(19) United States
(12) Patent Application Publication
(10) Pub. No.: US 2009/0159413 A1
(43) Pub. Date: Jun. 25, 2009

(54) SWITCHGEAR SYSTEM

(76) Inventor: Guruge Elmo Laksham Perera, Hertfordshire (GB)

Correspondence Address: KOPPEL, PATRICK, HEYBL & DAWSON, 2815 Townsgate Road, SUITE 215, Westlake Village, CA, 91361-5827, US

(21) Appl. No.: 11/569,659

(22) PCT Filed: May 26, 2005
(86) PCT No.: PCT/GB05/02114

§ 371 Date: Jun. 29, 2007

(30) Foreign Application Priority Data
May 26, 2004 (GB) 0411802.2

(51) Int. Cl. H01H 13/00

(52) U.S. Cl. 200/329

(57) ABSTRACT

A circuit breaker with electrical contacts adapted to open or close thereby preventing or allowing respectively current to be supplied from one pair of an electrical system to a further part of the electrical system. The circuit breaker is provided with a storage device for storing data indicative of the zero crossing points of the current signal and an actuator arrangement for causing the electrical contacts of the circuit breaker to be opened or closed in accordance with the data indicative of the zero points of the current signal. The system synchronises the zero energy state of the a.c. system with the rapid opening of the contacts thereby circumventing an arc in the circuit breaker. Preferably, the actuator is an electrical linear motor whose armature is provided with a position detector to provide feedback control of the motor.

The present invention relates to switchgear system typically utilised in high voltage systems. In particular, the present invention relates to a digitally controlled switch gear system adapted to prevent an arc in the switchgear circuit breaker when the contacts of the circuit breaker are opened or closed.

Electrical energy generation and distribution requires switchgear for switching, controlling and protecting all networks, circuits and equipment. Reliability of the supply depends on the switchgear since it can isolate a faulty section from the remainder of the circuit by absolute discrimination whilst continuing supply in the healthy sections. Rapid response of the switchgear will protect generators, transformers and other equipment from short-circuit currents.

A relay in the switchgear detects the fault and supplies the information to the breaker for circuit interruption. Therefore the circuit breaker operates under all conditions i.e. no load, full load and fault conditions. When the contacts of a circuit breaker are separated under fault conditions, an arc is struck between them. The current is thus able to continue until the discharge ceases. The production of an arc delays the current interruption process and generates excessive heat, which may cause damage to the system or to the circuit breaker itself. Therefore, the main challenge in current circuit breaker technology is to extinguish the arc within the shortest possible time so that heat generated by it will not reach a dangerous value.

All modern high power switchgear for a.c. systems uses low resistance or current zero methods for attempting to achieve arc extinction. In an a.c. system, the current drops to zero after every half cycle and the arc extinguishes for a brief moment. However, the medium between the contacts contains ions and electrons so that it has low dielectric strength and is often broken down by the rising contact voltage (re-striking voltage). If such breakdown does occur, the arc persists for another half-cycle.

Current switchgear devices increase the dielectric constant of the medium by blowing air or/and gas, inert gas such as SF6, or having a vacuum in the arcing chamber. This increases the dielectric strength of the medium more rapidly than the voltage across the contacts and extinguishes the arc. Therefore, these arc extinguishing techniques rely on the gaseous environment of the medium between the contacts.

The present invention avoids such requirements and proposes to construct a device to synchronise the zero energy state of the a.c. system with the rapid opening of the contacts thereby circumventing an arc in the switchgear circuit breaker.

Further the present invention proposes to construct a device to minimise the transient effects by re-routing them away from the circuit breaker contacts by creating a least resistant path to a surge absorber or a similar device.

Furthermore, the present invention proposes to construct switchgear that will eliminate or minirnise the re-striking voltage at the contact separation or meeting points to avoid the creation of the arc.

More specifically, the present invention provides an electrical system utilising a current signal, the system comprising; a switchgear comprising a circuit breaker with electrical contacts adapted to open or close thereby preventing or allowing respectively, current to be supplied to a part of the electrical system; a storage means for storing data indicative of the zero points of the current signal; and a actuator for causing the electrical contacts of the circuit breaker to be opened or closed in accordance with the data indicative of the zero points of the current signal.

Preferably, operation of the circuit breaker is controlled by an electromagnetic linear actuator.

In order that the present invention be more readily understood, embodiments thereof will now be described by way of example with reference to the accompanying drawings in which:

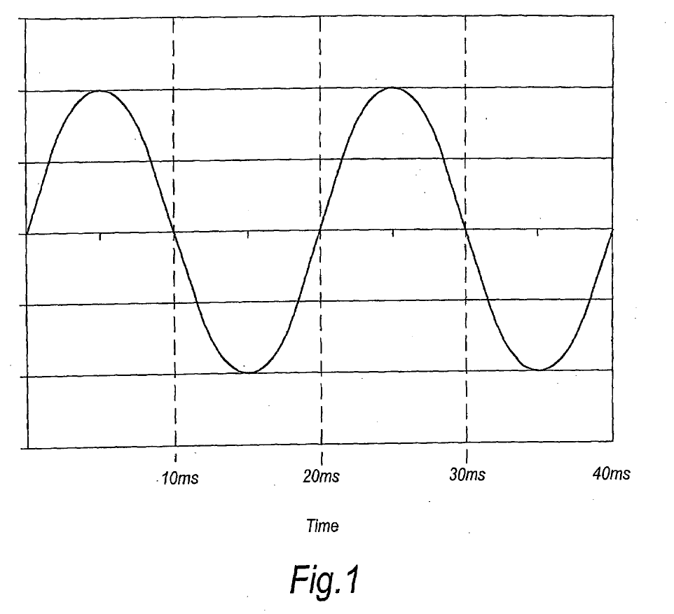

FIG. 1 shows an example of 50 Hz current signal utilised in a preferred embodiment of the present invention;

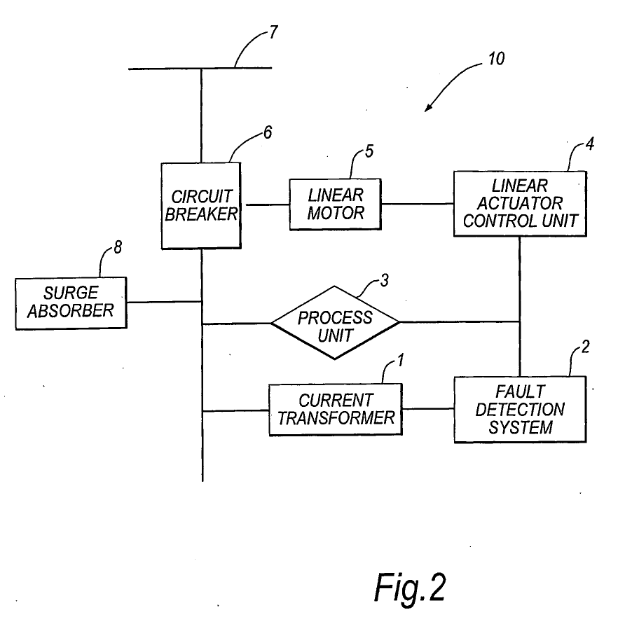

FIG. 2 shows a schematic diagram of the preferred embodiment of the electrical system according to the present invention.

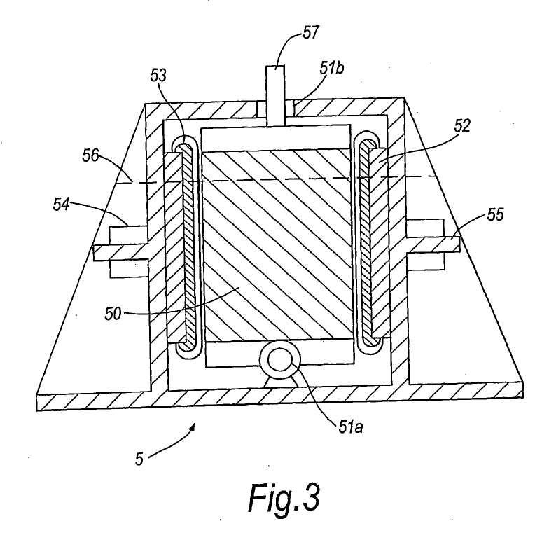

FIG. 3 shows a linear actuator according to the preferred embodiment of the present invention.

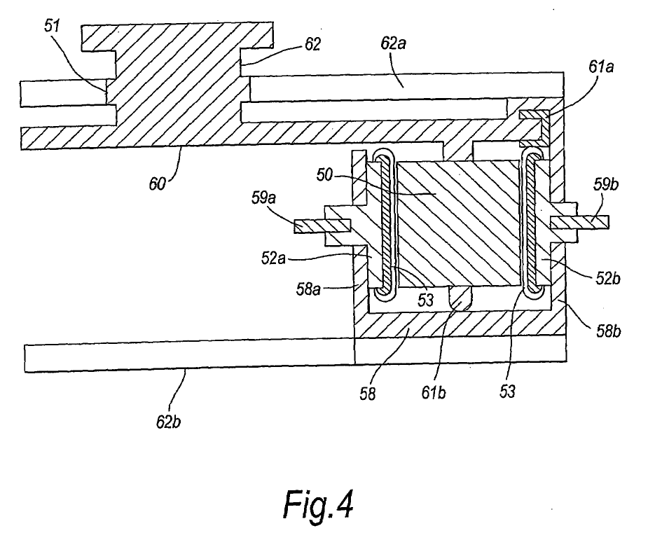

FIG. 4 shows a linear actuator according to a further embodiment of the present invention.

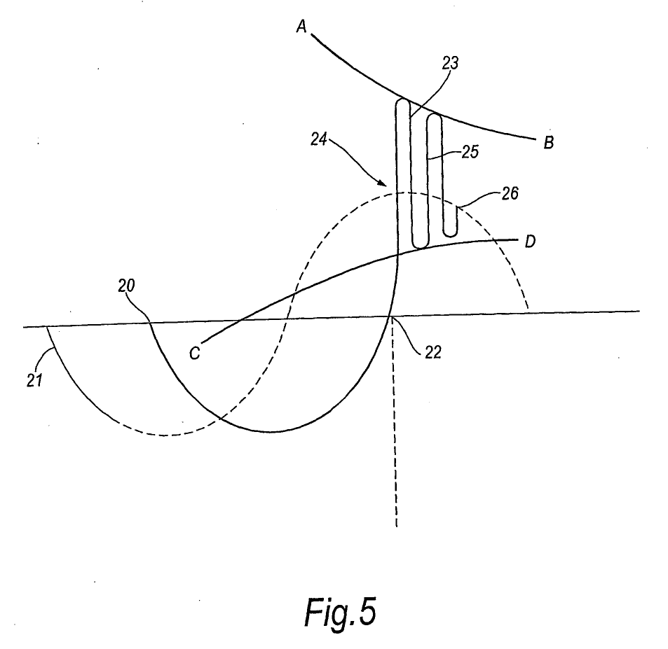

FIG. 5 shows a waveform representation of the restriking and recovery voltages at a zero current point in the system of FIG. 2.

Referring to FIG. 1, two cycles of a typical 50 Hz alternating current (A.C.) waveform utilised in a preferred embodiment of the present invention is shown. It will be appreciated that the present invention is not limited for use with a 50 Hz waveform.

A 50 Hz A.C. system will have zero point every half cycle. That is, the period T of a 50 Hz waveform is 20 ms and thus a zero point will occur every 10 ms.

As mentioned hereinbefore, it is desirable to prevent arc creation across the contacts of a circuit breaker by opening or closing the contacts of the circuit breaker when the energy in the system is at a minimum which approximates to when the current is at zero in the A.C. waveform.

Preferably, the present invention utilises a linear electrical actuator to synchronise the opening of the contacts with the zero current at the opening terminals.

Using a linear electric motor this is achieved by delivering a power (100 kN peak), at a speed (5 m/s), at a high bandwidth 400 Hz (1.25 ms response time). A digitally controlled electromagnetic linear actuator with a 1.25 ms response time (eight times faster) enables the actuator to deliver the peak force necessary to open/close contacts at precisely the A.C. system zero energy point.

This will allow the actuator to optimise the delivery of power and speed to the contact points synchronising the zero current of the A.C. system opening of the contacts. The use of a position transducer or a similar device gives a feedback loop for self-diagnostics and/or provide optimisation and further adjustments to the actuator operation and synchronise the opening or closing of the contacts with the zero current point of the a.c. system.

With reference to FIG. 2, a preferred embodiment of the switchgear system 10 according to the present invention is shown.

A switchgear system 10 comprises a current transformer 1 which is arranged to operate a fault detection system 2 which is preferably a relay arrangement. The level of the electromotive force (e.m.f.) in the secondary of the current transformer determines whether the fault detection system is activated.

A circuit breaker 6 comprises a pair of contacts which are either in an open or close position. In the open position, current is not provided to bus-bar 7 whereas in the close position, current is provided. Bus-bar 7 is typically connected to an electrical system which requires fault protection.

Under normal operating conditions, the contacts of the circuit breaker remain closed and thus carry the full load current continuously. Typically in this condition, the e.m.f. in the secondary winding of the current transformer 1 is insufficient to operate the relay arrangement 2.

When a fault occurs, the resulting over-current in the current transformer 1 primary winding increases the secondary e.m.f. and causes linear actuator control unit 4 to be activated. The linear actuator control unit 4 is configured to drive the linear actuator 5 such that when a signal is received from the fault detection system 2 indicating that a fault has occurred, control unit 4 drives the linear motor 5 to activate the circuit breaker 6 and open the contacts. This action interrupts the current output onto the bus-bar 7.

It will be appreciated that the linear actuator control unit 4 may be adapted to open or close the circuit breaker 6 contacts by a manual or remote controlled mechanism in the control unit 4.

Process unit 3 is arranged to communicate with all elements of the system 10. In particular the process unit 3 operates to monitor the A.C. current and to synchronism the zero energy point of the A.C. system with the contact separation point of the circuit breaker thus avoiding the creation of the arc.

The process unit 3 stores data which indicates when a zero energy point occurs in the A.C. system. This data may be calculated separately and entered into the process unit memory (not shown). Alternatively the process unit may be provided with means for determining when a zero current crossing point occurs and thus enable the process unit to calculate the zero energy point without the data having to be stored in the memory manually. This latter feature may be useful by compensating for errors in the actual current wave which may contain harmonics leading to an incorrect detection of a zero crossing point. The determining means would compute a pure current wave and synchronise the zero point of the pure current wave thereby providing an accurate wave representation on which to base the operation of the actuator.

Furthermore a position transducer detection system (not shown) in the linear motor 5 may be provided and is used as an intelligent feed-back system to make corrections to the linear motor actuation and the contact opening of the circuit breaker to open and close contacts at the zero current point of the a.c. system to avoid or to keep the ionisation between the contacts in the circuit breaker 6 sufficiently low at a level below the critical point to avoid the arc.

A transient voltage absorber 8 or any other suitable system connected to the system at an appropriate position may be used to reduce the transient effects in the system.

With the above system, the energy level at the time and point of separation of the contacts is insufficient to produce ionisation or to provide energy to the ions or electrons in the medium between the contacts thereby preventing the initiation of the arc.

In addition, to conserve the energy of the actuator, during deceleration of the actuators in the opening of the contacts, the energy released by the actuator may be transferred to a storage such as a bank of capacitors which would be configured to re-use the energy when closing the contacts. This results in the system being very efficient and contributes to the actuator being a low energy device.

A linear actuator assembly 5 according to the preferred embodiment of the present invention will now be described in more detail with reference to FIG. 3.

FIG. 3 shows a cross-section of a particular form of the device in which the armature or piston 50 is mounted on precision bearings 51a and runs in an elongate channel between the plane surfaces of the stator plates 52 to which are bonded the coils 53. The magnetic flux from each force unit of the armature intersects the coils and returns via the iron plates 52 that are securely fixed to the stator via keying pieces 54 that are held by horizontal reinforcing ribs 55. The stator sides are braced at intervals along their length by vertical ribs 56 so as to resist the magnetic forces between the armature magnets 50 and the stator plates 52.

The axial force on the armature is carried out of the machine by the fin 57, that runs in bearings 51b in a slot on the stator wall and may also be fitted with a sealing strip (not shown) to exclude dust from the channel and hence the armature.

The fin 57 is arranged to communicate with the contacts of the circuit breaker 6 in response to a signal being provided to the linear motor assembly 5 by linear actuator control unit 4.

FIG. 4 shows an alternative linear actuator assembly 5 according to a further embodiment of the present invention. It will be appreciated that the same reference numerals are utilised as in FIG. 3 for corresponding features.

According to this embodiment, a moving magnet “drum” armature moves in a channel-shaped stator. By this means the inward and outward radial forces on the armature are closely balanced at all times near to the periphery of the machine.

The armature 50 moves between coil units 53 that are bonded to inner 52a and outer 52b sector plates of a circular stator channel 58. The inner 52a and outer 52b sector plates are positioned on opposing walls 58a, 58b of the channel 58 and thus the coil units 53 that are bonded to the inner 52a and outer 52b sector plates respectively, provide opposing magnetic fields to the armature which is displaced therethrough. The coil units 53 provide a magnetic field which balances with the magnetic field of the armature so as prevent any resultant radial force being conveyed from the motor. It will be understood that there may be eight inner sector plates and eight outer sector plates making up the complete stator. To withstand the strong magnetic forces drawing them to the armature, the plates are keyed into inner and outer bracing rings 59a and 59b.

The armature is axially constrained by ring bearings 51 that are incorporated into the stator construction and prevent the armature assembly from contacting the peripheral stator wall. In addition, the armature 50 is supported by stout disc 60 that is part of torque shaft 62. Thus no large radial forces remain to be conveyed inwards to the central bearings of torque disc 62a, 62b.

A further ring bearing 61a may be provided between the outer edge of the stout disc 60 and the peripheral wall of the stator assembly so as to augment the effect of the ring bearings 51. Further, a supporting bearing 61b is preferably provided under the armature 50, which prevents the lower portion of the armature from contacting the stator assembly. The supporting bearing 61b may be a slide bearing extending along the channel shaped stator. Alternatively, a bearing may be arranged in each sector of the stator or in only some of the sectors of the stator. It should be noted that the magnetic forces within the machine provide a useful benefit in that the armature is strongly attracted to rotate in a plate that is positioned in the centre of the stator in an axial direction. That phenomenon assists the action of the bearings that provide axial constraint and so reduces the consequent wear.

The supporting bearing 61b is preferably provided when the motor is configured as shown in FIG. 4 such that the stout disc 60 is positioned above the armature 50. However, it will be appreciated that the supporting bearing 61b may not be required if the motor is flipped over such that the stout disc is positioned below the armature 50 as gravitational forces will allow the armature to balance on the stout disc 60.

Thus the large force provided by the motor configuration is arranged to interact with the contacts of the circuit breaker 6 to either open or close them in response to a signal from the linear actuator control unit 4.

It will be appreciated that other types of actuator may be utilised instead of those shown in FIGS. 3 or 4. For example, it is possible to utilise the actuator described in GB0309531.2 to achieve the desired effect of high power, high speed and high bandwidth equal or greater than the frequency of the a.c. system.

In addition to the above, the switchgear system according to the present invention minimises the re-striking voltage at the contact separation or meeting points to avoid creation of an arc and this concept will now be described in more detail with reference to FIG. 5.

FIG. 5 shows a relative waveform representation of the fault current 20 and the system voltage 21. When the contacts of the circuit breaker are opened at the zero current point 22 of the fault current 20, a high frequency transient voltage 23 appears across the contacts as a result of the rapid distribution of energy between the magnetic and electric fields associated with the plant and transmission line of the a.c. system.

The rise in the restriking voltage 23 is maintained within recovery zone 24 where the dielectric strength of the medium is kept sufficiently high to avoid an arc due to the restriking voltage 23. Transient oscillations 25 subside rapidly due to the damping effect of the system resistance and normal system voltage 21 appears across the contacts making it the recovery voltage 26.

In summary, the switchgear device opens at zero energy of the a.c. system by optimising linear motor peak thrust, speed and bandwidth to synchronise the opening of the contact points of the circuit breaker.

Further, the switchgear manages transient effects by re-routing them through a least resistant path and optimising the circuit with a surge absorber or other similar device.

Moreover the device will eliminate or minimise the re-striking voltage at the contact separation or meeting points to avoid the creation of the arc. It will be appreciated that the above mentioned system is implemented in high voltage power systems i.e. above domestic UK mains supply of 240V, and preferably above 6.6 kV.

1. An electrical system utilising a current signal, the system comprising a circuit breaker with electrical contacts adapted to open or close thereby preventing or allowing respectively current to be supplied to a part of the electrical system; a storage means for storing data indicative of the zero points of the current signal; and an actuation means for causing the electrical contacts in the circuit breaker to be opened or closed in accordance with the data indicative of the zero points of the current signal.

2. An electrical system according to claim 1 and comprising a processor unit connected to the storage means and wherein the actuation means comprises a linear actuator for controlling the operation of the circuit breaker.

3. An electrical system according to claim 2, wherein the actuation means includes a reciprocating member and means for detecting the position of the reciprocating member

4. An electrical system according to claim 2, and comprising a transient voltage absorber unit for reducing the effects of changes in voltage resulting from opening or closing the contacts.

5. An electrical system according to claim 2, wherein the linear actuator is an electromagnetic device.

6. An electrical system according to claim 5, wherein the device is a linear motor.

7. An electrical system according to claim 6, wherein the linear motor comprises a moving magnet armature retained in a channel shaped stator.

8. An electrical system according to claim 7, wherein the armature is provided with a position detecting device arranged to provide a position signal to the processor unit.

9. An electrical system according to claim 7, wherein the stator includes coil units provided on stator plates.

10. An electrical system according to claim 9, wherein the armature is provided with a position detecting device arranged to provide a position signal to the processor unit.

11. An electrical system according to claim 1, wherein the actuation means includes a reciprocating member and means for detecting the position of the reciprocating member.

12. An electrical system according to claim 11, and comprising a transient voltage absorber unit for reducing the effects of changes in voltage resulting from opening or closing the contacts.

13. An electrical system according to claim 1, and comprising a transient voltage absorber unit for reducing the effects of changes in voltage resulting from opening or closing the contacts.

14. An electrical system according to claim 13, wherein the transient voltage absorber unit comprises a least resistance path from the circuit breaker contacts to a surge absorber.
